(19) United States
(12) Patent Application Publication
(10) Pub. No.: US 2022/0301068 A1
(43) Pub. Date: Sep. 22, 2022

(54) Method for Managing and Administering a Fixed Indexed Life or Annuity Crediting Strategy Allocation Between a Traditional Index Linked Crediting Strategy and a Volatility-Controlled Index Linked Crediting Strategy

(71) Applicant: Symetra Life Insurance Company, Bellevue, WA (US)

(72) Inventor: Brian Clark, Clive, IA (US)

(73) Assignee: Symetra Life Insurance Company, Bellevue, WA (US)

(21) Appl. No.: 17/692,703

(22) Filed: Mar. 11, 2022

Related U.S. Application Data
(60) Provisional application No. 63/163,261, filed on Mar. 19, 2021.

(51) Int. Cl. G06Q 40/08

(52) U.S. Cl. CPC G06Q 40/08

(57) ABSTRACT

A method and system for managing and administering a financial product having a segment. A fixed indexed crediting strategy is allocated between two or more different types of indexed crediting strategies based on an indicator of market volatility or option costs relative to a defined benchmark. The two or more types of indexed crediting strategies are traditional index linked crediting strategies and at least one volatility-controlled index linked crediting strategy. The method includes determining an indicator and setting a benchmark. The value of the indicator is compared to the value of the benchmark. The system allocates the segment to the traditional index linked crediting strategy or strategies if the indicator is below the benchmark and allocates the segment to the volatility-controlled index linked crediting strategy or strategies if the indicator is above the benchmark.

### BACKGROUND

This application is based upon U.S. Provisional Application Ser. No. 63/163,261 filed Mar. 19, 2021, the complete disclosure of which is hereby expressly incorporated by this reference.

The permanent life insurance and annuity market can be segmented into two broad categories, fixed and variable. Fixed products have underlying guarantees which appeal to conservative buyers. Policy cash values receive a declared credited rate which cannot be negative, providing consumers protection from market risks. Variable products allow the policy owner to invest in sub-accounts that participate directly in the stock and bond markets and their associated risks and potential for investment gains.

In the mid to late 1990s both life and annuity carriers began innovating with a hybrid category known as “fixed indexed” products. They are “fixed” products because the declared credited rate cannot be negative. Instead of declaring a fixed rate for the forthcoming term, the product offers a credited rate linked to an external index such as the S&P 500. At the beginning of the term the parameters and formulas are defined as to how the credited rate will be calculated at the end of the term based on the specified index performance during the term. The parameters are often referred to as “participation rates” or “caps” (i.e., the maximum rate possible). The term is typically one-year but two, three and sometimes longer-year terms have been available.

When a policy owner allocates some of their account value to an indexed strategy, those funds are moved into a “segment.” At the end of the segment's term, any interest credits earned are added to the segment and the total value of the segment is eligible for reallocation to the same or a different crediting strategy. The products are popular with consumers due to the downside protection, some upside potential tied to the index, and the fact that interest gains that have been credited to the policy are no longer subject to the downside risk of the market.

A popular crediting strategy is the S&P 500 one-year capped strategy. The company declares a “cap” which is the maximum credited rate possible for that one-year term. The policy owner receives 100% of the growth in the index for the term up to the cap. For example, if the cap is 8% and the index earns 12% then the funds for that segment receives an 8% credited rate. If the index growth is 5% then the credited rate for that segment is also 5%. If the index declines 30% over the term, the credited rate is zero.

The insurance industry invented a wide variety of index-linked credited strategies over the years, varying both the underlying index as well as how the credited rate is calculated based on the index performance. Most products offer multiple crediting strategies for the policy owner to allocate the account. Once the policy owner allocates funds to a segment the funds generally cannot be reallocated to a different segment until that segment matures. To manage the hedging process, the insurance company will specify a “buy date” when available funds can be swept into a new segment. For life insurance policies the buy date is typically once a month; for annuities it is much more frequently.

Insurance carriers support index-linked crediting strategy by hedging with derivative instruments (e.g., typically companies purchase call options that will replicate the credited interest obligation but some may dynamically hedge the liability instead). The insurance company is not taking a market risk. They are managing the spread or difference between the yield on the bond portfolio and the cost of the call options to cover expenses and make a profit. With fixed indexed products, the carrier's primary risk is volatility of the call option prices and whether they can sufficiently adjust the participation rates and caps quickly enough in response to higher option costs.

Due to falling investment yields, higher option costs and competitive pressures, the insurance industry began innovating with alternative strategies known as “volatility-controlled” indices. Volatility-controlled index means any manufactured or managed index where the underlying allocation to various asset classes (e.g., equities, bonds, commodities, real estate, cash) are managed by an algorithm that periodically adjusts the asset allocation within the index. Such indices typically utilize a diversified set of asset classes but in the most basic form the index could consist of only two asset classes: equities and cash. The allocation to the various asset classes is dynamically adjusted periodically (e.g., monthly) based on an algorithm whose rules and asset class constraints are pre-set and the algorithm's goal is to manage the portfolio allocation to achieve an overall targeted volatility level. Effectively this means the allocation to equities within the index is variable: as market volatility increases the equity allocation will decline (and vice versa).

Insurance companies can benefit from volatility-controlled indices because the option costs are stable, an attractive characteristic to the carriers since it reduces their spread management risk. For example, the option cost for one year's participation in the S&P 500 index has ranged from 6% to 15%. In contrast, the option cost for one year's participation in a volatility-controlled index targeting a 5% annualized volatility is generally in the 2.5%-3.5% % range, depending on the frequency the index rebalances. Even small changes in S&P 500 option costs, if not reflected in a lower participation rate or cap, can be more than the product's profitability for that year. Consumers can also benefit from the volatility-controlled option cost characteristic because the carrier may be able to offer an attractive, uncapped participation rate on that volatility-controlled index.

Traditional equity-linked strategies and volatility-controlled indices are fundamentally different and consumers and/or their agent may benefit from guidance on allocating the funds to the different categories of indices based on market volatility conditions. Traditional equity-indexed indices are not actively managed. Except for infrequent changes to the companies in the index, the index can be considered a “buy and hold” position in the market. The policy owner is always participating in the same core asset class—the designated index—for the entire term. In contrast, the equity exposure within a volatility-controlled index is managed by the algorithm and will likely change during the segment term. Rising market volatility will trigger the algorithm to reduce equity exposure and get defensive; falling market volatility will trigger the algorithm to increase equity exposure and thus become more aggressive.

FIG. 1 demonstrates this behavior for a volatility-controlled index, the JP Morgan's Efficiente 5. The chart demonstrates the changes in allocation over two separate 6-month periods, with the total equity allocation noted in column titled “Total Equity Allocation.” In the top chart, the total equity allocation declines due to rising equity market volatility. In the bottom chart, the total equity allocation increases due to falling equity market volatility.

The expected return on an equity index should outperform a diversified volatility-controlled index over time due to the long-term expected performance of equities as an asset class over the more-conservative asset classes used within the volatility-controlled index. This is not the relevant question for policy owners of fixed indexed products because their downside is protected from losses over the segment term. Policy owners are only concerned with the upside participation in the index. Since option costs are lower for volatility-controlled indices, participation rates are higher than the more volatility equity indices for the same option budget.

For a fixed option budget, the insurance company can offer the policy owner the most equity participation with the traditional strategy when market volatility is low. When market volatility is high, locking in a low equity participation rate may be less beneficial than participating in a volatility-controlled index that will have a low equity allocation at the start of the segment (due to the high market volatility) but will increase the equity allocation over the course of the term if market conditions improve.

For any given buy-date, the insurance company will have an option budget for the product. The company will set the caps and/or participation rates for the traditional index strategies based on their option costs and similarly for the volatility-controlled index strategies (which have lower and more stable option costs). As a result, the volatility-controlled strategies offer a higher participating rate than the traditional equity indexed strategies within the same product.

The two types of indexes could not be more different: the traditional strategy is one asset class (e.g., an equity index) and maintains the same exposure throughout the segment term whereas the volatility-controlled index is more diversified and changing the allocation mix during the segment term. The implications on expected performance on these two fundamentally different indices, and how much of the index gain can be offered by the insurance company because the option cost dynamics are also significantly different.

Policy owners of fixed index products that offer both traditional equity-linked index crediting strategies and volatility-controlled index-linked crediting strategies may benefit from an innovative method to manage their segment allocation between the choices of traditional equity-linked strategies and volatility-controlled index strategies.

Before discussing the invention's method and system to provide this allocation decision making tool for the policy owner, the next section summarizes noted inventions in the insurance industry related to methods that impact the expected performance of crediting strategies.

### Other Patents Related to Managing Fixed Indexed Crediting Strategies

There are several patents related to the administration of dynamically adjusted crediting strategies for fixed and fixed indexed insurance products. They are summarized in this section to help establish the differences from the present disclosure. Some of the referenced patents relate only to traditional fixed products but still provide additional context on differentiation.

In U.S. Pat. No. 8,036,968 (Abbs et al.) the inventors describe an annuity having a credited rate coupled with a referenced rate. In this design, the policy owner's annuity is purchased with a declared credited rate and an external reference rate at the time of purchase (e.g., a base rate). During a specified term, the credited rate will be reset to a higher rate if the external reference rate is higher than the base rate at the time the annual credited rate is declared. In this method, the policy owner effectively has an adjustable credited rate based on changes in an external reference rate with a minimum credited rate. In this patent, the method is not using any external value or indicator to allocate the policy funds between separate and distinct crediting strategies linked to an external index. The method merely uses an external “reference rate” to determine if the fixed rate will be declared higher.

In U.S. Pat. No. 7,376,609 (Clark et al.) the inventors describe a method and process for lengthening the underlying guarantee true-up on an index-linked crediting strategy for purposes of maximizing the available hedged investment budget so the insurance company has more call option buying capacity. More buying capacity translates into more market participation for the policy owner's segment. In this method, the policy owner is participating in a selected index-linked crediting strategy and the invented method maximizes the upside potential credited rate for the policy owner while still providing a cumulative minimum guaranteed rate over the term. The method shares a common goal with the invention described herein in managing a method to enhance the long-term performance of a crediting strategy linked to an equity index. The method in U.S. Pat. No. 7,376,609 in no way is managing the allocation for the policy owner between fundamentally different indexed linked strategies.

U.S. Pat. Nos. 8,224,736 and 8,452,686 are similar and provided by the same inventor (Baiye). They describe a method and process to administer a fixed rate annuity with two crediting strategies: an annually reset crediting strategy and a multi-year guaranteed rate strategy. In this method the policy owner can elect to have their policy values automatically switch to the multi-year guaranteed rate strategy should the credited rate on the annuity reset strategy fall below the rate on the multi-year guaranteed strategy. In this method there is no external rate being referenced to choose between two fixed crediting strategies. The patent's method simply examines the performance of the reset strategy (e.g., the credited rate) to determine if the policy owner would benefit from moving the funds to the alternative crediting strategy which is offering a higher credited rate at that time.

In U.S. Pat. No. 8,260,698 (Baiye) the inventor describes a method and process for administering a fixed rate annuity with a base credited rate established at issue and interest bonuses credited to the policy tied to changes in external indices. In one method, the interest bonus is tied to changes in the consumer price index. In another method, the interest bonus is tied to changes in the difference between a short term and a long-term Treasury bond interest rate (e.g., changes in the steepness of the Treasury rate curve). In these methods the policy owner is selecting a crediting strategy whereby the policy funds receive a minimum rate set at policy issue and a bonus based on an external indicator (i.e., the CPI or two designated Treasury rates). While this patent's method is using an external indicator to determine the total credited rate each year, it is not in any way making periodic decisions which strategy the policy owner should allocate their funds.

Fixed indexed products link the crediting rate to external indices such as the S&P 500 stock price index which is a price only index. Dividends paid on the stocks in the index are not reflected. This is common practice in the industry since insurance companies hedge the credited rate obligation by purchasing call options whose payoff is tied to changes in the index. In U.S. Pat. No. 8,359,258 (Michalowski et al.) the inventors describe a method and system to administer fixed indexed annuities where the credited rate is tied to an alternative index value with dividends reflected in the index value. In effect the inventors are incorporating an additional external input (the dividends paid on the underlying stocks) along with the index itself to determine the policy owner's credited rate. This method is using external data to modify the value of the index for purposes of calculating the index-linked credited rate. It does not appear the inventors discussed how this invention enhances the consumer value since the cost of including dividends in the index growth would need to be reflected in the base participation rate.

In U.S. Pat. No. 8,285,566 (McSwaney et al.) the inventor describes a method and system for administering an indexed universal life product with an indexed crediting strategy based on multiple indices with non-uniform weights and such weights determined at the end of the segment term based on the relative performance of each index. In effect, the method promotes the benefit of hindsight (e.g., the best performing index in the group gets the highest allocation, the worst gets the lowest allocation). The method in this invention is similar to the present invention in that it effectively describes three indices and uses an external indicator (in this case, the performance of each of the indices) to determine the policy owner's allocation. The provider of the options to hedge this combination construction are apparently utilizing the expected correlation between three different equity indices and pricing in the cost of potential variances in relative performance. Furthermore, the losses in one index would offset the gains in the better performance indices, a feature that separate crediting strategies within a product do not allow. None of these strategies utilized a volatility-controlled index; they were all traditional “buy and hold” equity indices.

These inventions have the common goal of describing methods and processes for administering dynamically determined crediting rates based in part on internal or external indicators or values with the goal of providing a better value for the policy owner. No invention to date relates to a method and process for using an external indicator or calculated value to decide where to allocate the policy owner's premium or funds between two fundamentally different indexed crediting strategies, a traditional “buy and hold” index and a volatility-controlled index.

The recent innovation of volatility-controlled indices within fixed indexed insurance products signals a paradigm shift for the industry. Insurers are striving to better manage their exposure to hedging cost volatility with the use of volatility-controlled indices. Consumers are increasingly presented with a variety of crediting strategies which now include indices that are dynamically managed. Accordingly, there is a need for a method and supporting system to assist policy owners with the allocation decision to enhance their long term expected credited rate performance.

### SUMMARY OF INVENTION

One embodiment of the invention relates to a method and system for managing the allocation of a fixed indexed insurance or annuity product policy owner's segment between two or more designated index crediting strategies where at least one crediting strategy is linked to a “volatility-controlled” index. The method applies to all index crediting strategy terms, including one-year terms, two-year terms, and longer.

An “indexed crediting strategy” includes any insurance product that provides an account value with a portion of that account value (referred to as a “segment”) that earns a credited rate at the end of the designated interest term where the credited rate cannot be negative and the rate is calculated based on a pre-determined index, a formula for calculating the credited rate using that index and parameters such as caps, spreads and/or participation rates.

For policy owners that select some or all of their funds within the product, the system manages the allocation decision between pre-determined traditional strategy(ies) linked to a market index and volatility-controlled index linked strategy(ies) based on a measure of market volatility (“the indicator”) relative to a pre-determined “benchmark” whether pre-set or dynamically calculated. The method allocates the policy owner's segment to traditional market indices when conditions are most favorable to lock in participation in that market index. Similarly, the method allocates the policy owner's segment to volatility-controlled indices when market volatility conditions are high, linking the policy holder's crediting strategy to an index that will dynamically increase equity allocation if volatility conditions normalize (e.g., decrease) during the interest term. Sometimes “interest term” is also referred to as “index term” since it is the term of the investment in the selected index. This allocation strategy is also favorable for the insurance company because it helps avoid the exposure related to purchasing call options on the traditional market index when such option costs are most expensive and volatile. Similarly, this allocation strategy may turn out to be favorable to the policy owner if the dynamic allocations embedded in the volatility-controlled index result in more indexed interest credited than would otherwise have been the case with the market index crediting strategy. However, there is no guarantee this will be the case.

In one embodiment the indicator is a commercially available index representing option costs. One example is the VIX® index published by the CBOE. While insurance companies are purchasing 12-month options to hedge the product and the VIX® index represents the 30-day implied volatility priced into option costs on the S&P 500, the VIX® index is a viable proxy for market conditions driving hedging or option costs.

In another embodiment the indicator is the market price for VIX® futures contracts. These are the cash futures contracts that have expiration dates several months in the future and may also be used as a proxy for the cost of options. The indicator could be pegged to a calculated futures contract price for a pre-determined time-period using then current futures contract prices before and after the targeted term.

In another embodiment the indicator is based on a calculation of realized volatility of the underlying index over a pre-determined time-period immediately preceding the buy date to determine the policy owner's allocation to one of the crediting strategies. Actual volatility is also a good proxy for market conditions to apply the method.

In another embodiment the indicator is based on market quotes for call options based on the underlying index for a pre-determined term and standardized set of option parameters (e.g., strike price relative to index value, term, etc.). One example of such embodiment is to compute the cost of options for exactly 1-year from the allocation decision date, based on a defined index (e.g., S&P 500) for at-the-money options.

In one embodiment the benchmark is fixed for the policy owner for the duration of their policy. The method and system would compare the calculated indicator and compare to the fixed benchmark to determine the policy owner's allocation to the available traditional indexed crediting strategies and volatility-controlled index crediting strategies.

In another embodiment the benchmark is variable for the policy owner and can be changed periodically over the duration of the policy based on a pre-determined methodology. In other words, the benchmark is set for a particular interest term, but can change between interest terms over the duration of the policy. For example, the benchmark could be linked to the value of the 10-year Treasury note as this is often used as a proxy for new investment yields. Other market parameters could equally be used to determine the benchmark level.

In one embodiment the method and system will use the selected or calculated indicator, compares its value to the selected or calculated benchmark and determine how the policy owner's segment is allocated between the pre-selected index crediting strategy alternatives.

Another embodiment includes a computer program product for processing data related to a fixed indexed financial product over a term, wherein the financial product has a segment that may be less than the entire account value. The computer program product includes at least one non-transitory computer-readable storage medium having computer-executable program code instructions stored therein. The computer-executable program code instructions comprising program code instructions to perform the steps of the method described herein.

### BRIEF DESCRIPTION OF THE DRAWINGS

For the purposes of facilitating an understanding of the invention, the accompanying drawings and detailed description illustrate embodiments thereof, from which the structures, construction and operation, processes, and many related advantages of the embodiment may be readily understood and appreciated.

The following diagrams are provided to enable those skilled in the art to make and use the described embodiments set formation. Various modifications, equivalents, variations, and alternatives, however, will remain readily apparent to those skilled in the art. Any and all such modifications, variations, equivalents, and alternatives are intended to fall within the spirit and scope of the present invention defined by the listed claims.

FIG. 1 is a table showing an exemplary asset allocation of the JP Morgan Efficiente 5 volatility-controlled index, demonstrating the variable nature of the asset allocation.

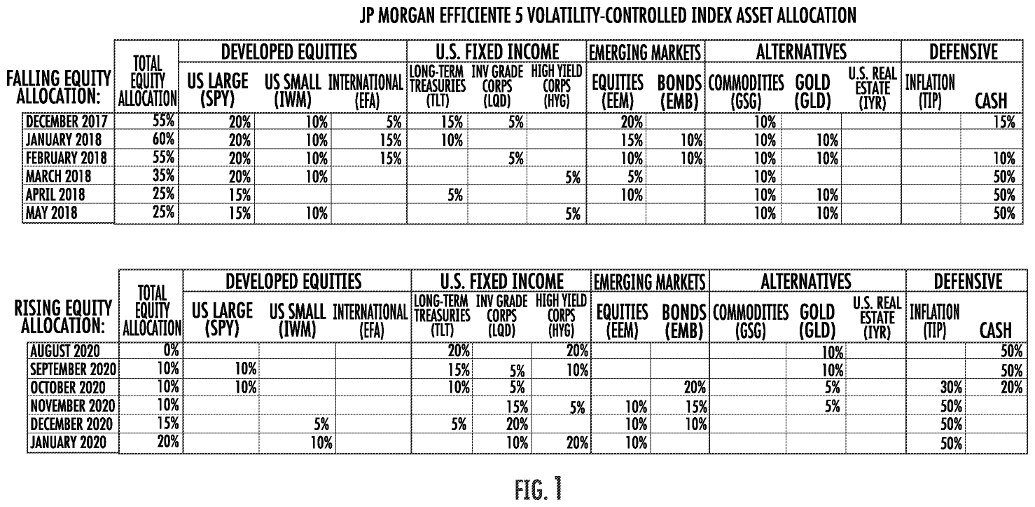

FIG. 2 is a process flow chart showing the method to determine a policy owner's allocation between a traditional indexed crediting strategy and a volatility-controlled index linked crediting strategy.

FIG. 3 is a table showing several examples of indicators for embodiments of the invention.

FIG. 4 is a table showing details of the calculations for selected numbers in FIG. 3.

FIG. 5 is a table showing an example of the calculations to compute a weighted average VIX® futures price for a 30-day term, one example for a potential indicator illustrated in FIG. 3.

FIG. 6 is a table showing details for a sample calculation of a 1-year S&P 500 call option price from exchange-traded quotes on SPX options, one potential indicator from FIG. 3.

FIG. 7 is a block diagram illustrating the components of a computer system connected to an electronic network necessary to execute embodiments of the invention.

FIG. 8 is a table showing how the method manages a policy owner's allocation between a traditional equity-indexed strategy and a volatility-controlled index strategy. The table also demonstrates the value created for an application of the invention to two selected strategies as compared to the common industry favored 1-year S&P 500 capped strategy.

FIG. 9 is a table summarizing a 21-year analysis to demonstrate and quantify the potential value of the invention for a policy owner. The analysis compares the expected performance for a traditional S&P 500 linked indexed crediting strategy vs. a volatility-controlled indexed crediting strategy in the fixed indexed product context (e.g., participate only in the upside over the one-year term assumed; decreases in the index are reflected in a 0% crediting rate.

### DETAILED DESCRIPTION

The invention includes a method, system, and computer program product for managing the crediting strategy allocation in a fixed indexed insurance or annuity product between a traditional index-linked crediting strategy and a volatility-controlled index-linked crediting strategy. A traditional indexed crediting strategy links the policy owner's credited rate to an external index (typically equities such as the S&P 500 index) but could include bond indices or hybrid indices that use a fixed allocation between multiple indices. In this context, “traditional” includes any index or combination of indices whereby such indices are not actively managed (e.g., other than periodic changes in the companies the index represents a basket of companies representing the market). “Volatility-controlled” includes any index where the underlying asset allocations are managed by an algorithm or some other means to achieve a targeted level of volatility.

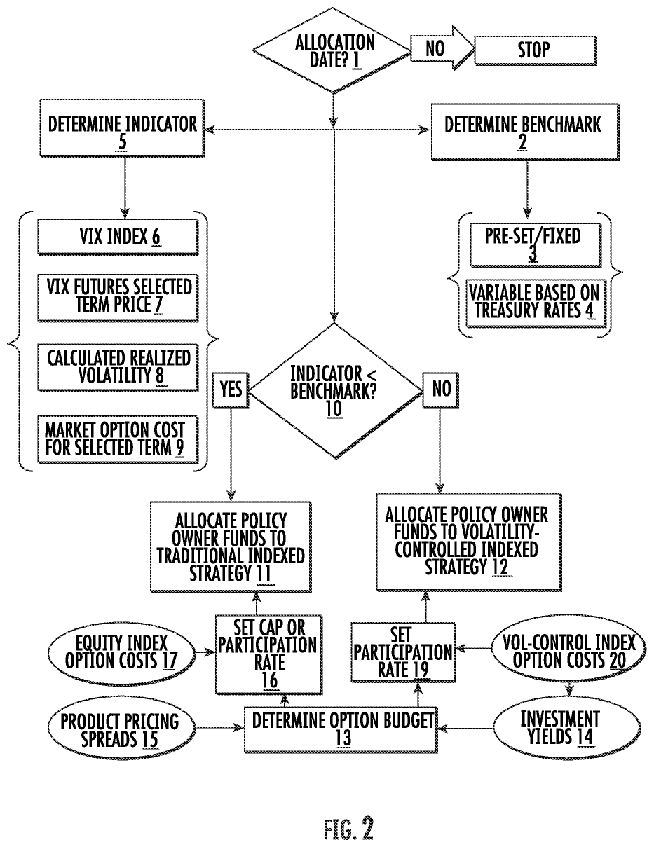

The process flow overview in FIG. 2 summarizes the method used to determine the allocation decision. The method shown in FIG. 2 presumes the allocation of the entire account value is 100% into one of two distinct strategies to demonstrate the concept. In other embodiments the method could be applied to multiple strategies using one or more indicators and/or benchmarks. For example, different segments of a single product's account value could have different indicators and/or benchmarks such that the different segments are allocated to different strategies. The method and system can be applied within a fixed indexed life or annuity product when at least one of the policy owner crediting options uses a volatility-controlled index-linked crediting strategy.

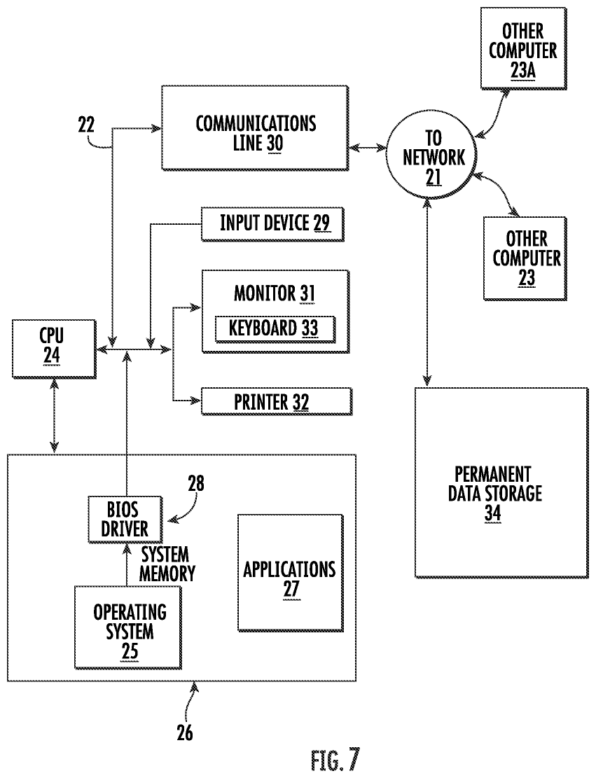

The method starts in FIG. 2 with step 1 where the computer system determines whether the current processing date aligns with a date the policy owner funds are allocated to a newly created indexed crediting segment. The computer system may include components such as shown in FIG. 7 and described below. The allocation date or “buy date” is often once a month on a pre-determined date for life insurance policies but may be more frequently for annuities (e.g., weekly). If the current date is not an allocation date, the computer stops processing.

On the allocation date the computer moves to step 2 to determine the benchmark that will be compared to the indicator derived in step 5. Determination of the benchmark can be done in several different ways. Step 3 shows one way of determining the benchmark wherein the benchmark is fixed or set for the life of the policy. The company could use historical option prices and index returns to determine the benchmark level that has the potential to create the desired of both lower option costs and higher index crediting over the life of the policy. Other methods could also be used.

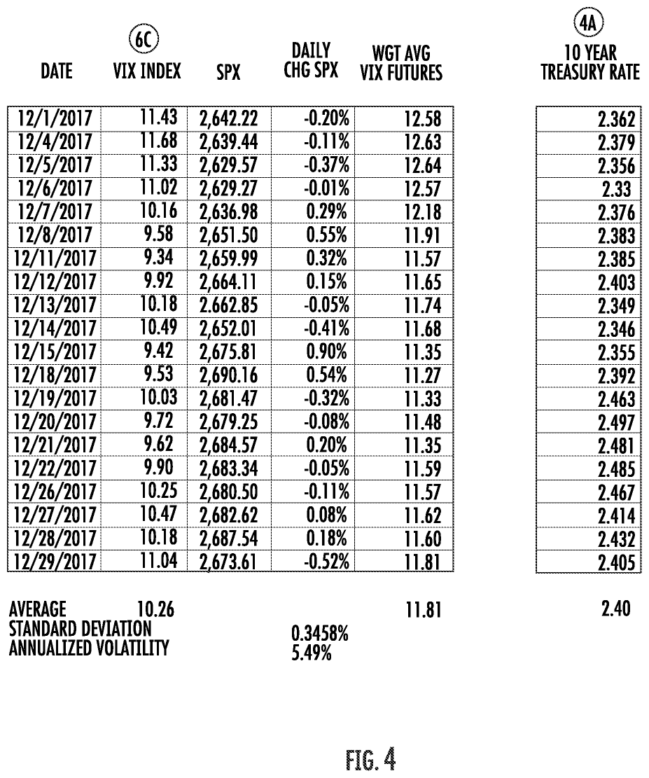

Step 4 shows another way of determining the benchmark wherein the benchmark is a variable that the computer calculates on the allocation date or any pre-determined date during the life of the policy (e.g., one variation would be to determine the benchmark annually and fix the benchmark for the forthcoming term (e.g., year)). The example listed in step 4 links the benchmark to Treasury rates. Column 4A on FIG. 4 shows the 10-year Treasury rate for the month of December 2017 as one such example. The benchmark could be based on the spot rate or an average over a specified term before the allocation date, for example. A simple example could be a method that sets the benchmark to A if the 10 Year Treasury is under X% otherwise it sets the benchmark to B.

Once the benchmark is determined for the allocation date, the system moves to step 5 to determine the current value of the indicator. Different embodiments may use different indicators. Or, in some embodiments the policy owner or insurance company may choose which indicator to use for the segment's term. Four categories of examples are listed in steps 6 through 9, but other suitable indicators could be used to derive a proxy for market volatility or option costs.

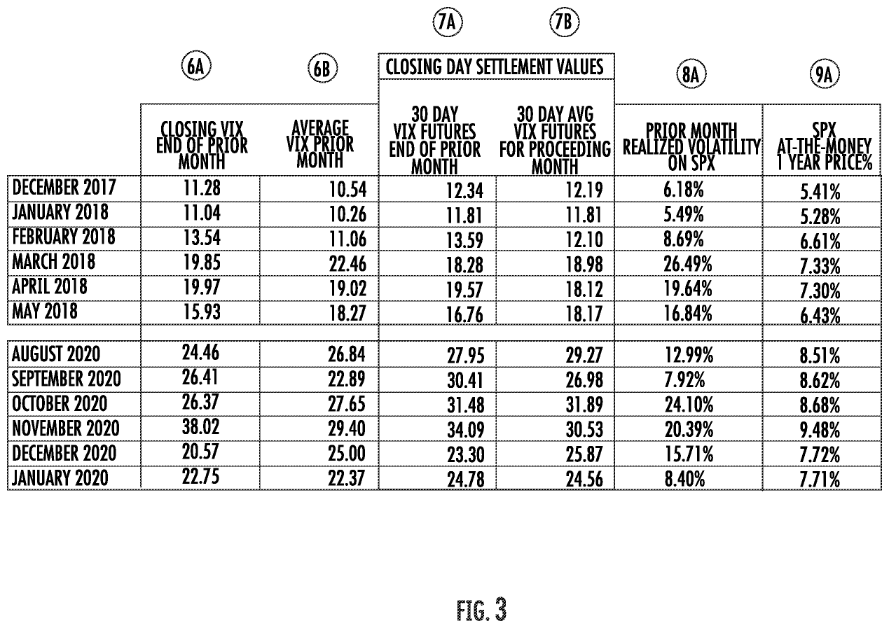

As shown in step 6, the VIX® index is one possible indicator. The VIX® index is the CBOE's proprietary index that measures 30-day implied volatility on S&P 500 index options. While insurance companies typically purchase 1-year call options to match the 1-year index crediting terms, the VIX® index is a proxy worthy of consideration for the method. Column 6A in FIG. 3 shows the spot value of the VIX® index for selected dates on the last trading day in the prior month for the calendar months from December 2017 through May 2018 and August 2020 through January 2021. Instead of using the spot VIX® index value, the method could use the average of the VIX® index over a pre-determined number of days for the indicator value. The example in FIG. 3, column 6B uses the average closing day values over the calendar month immediately preceding the month in question. Details for one such calculation, the December 2017 values, are shown in FIG. 4, column 6C.

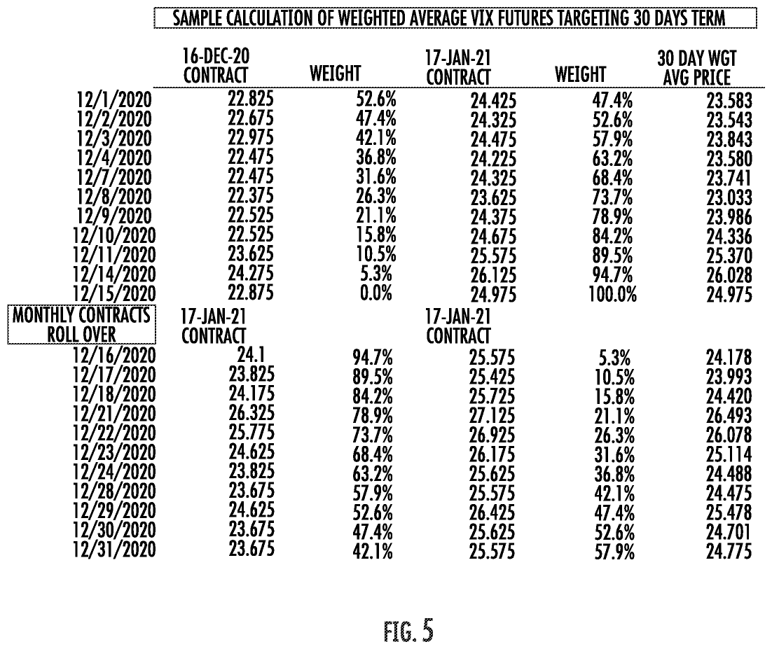

As shown in step 7, the VIX® futures prices are another possible indicator. The VIX® futures prices are related to the VIX® index but provide the designer of the method the ability to specify a term length. Since there are multiple VIX® futures contract prices with various expiration dates, the method could define a specified term and always compute the weighted average price of the VIX® futures price for the same term. One example is the weighted average price of the 30-day term of VIX® futures prices to align with the term date of the VIX® index. Columns 7 and 7B in FIG. 3 shows the spot prices and prior month average prices, respectively, for the 12 selected months. FIG. 4, column 7B provides details for the December 2017 calendar month average calculation. FIG. 5 provides details on the daily settlement prices of the two relevant VIX® futures contract prices needed to derive the weighted average price each day.

Using another indicator, the method could calculate volatility of the market directly from daily price movements in the index. Step 8 in FIG. 2 represents this general method of computing “realized volatility.” This method is less correlated with option pricing since it is looking backward at recent events whereas option pricing is a forward-looking exercise albeit heavily influenced by actual volatility in the market. There are many ways to calculate “realized volatility”; column 8A in FIG. 3 shows the results of one method using the prior month's closing day values of the S&P 500 index to compute the daily percentage change and convert that data into an annualized volatility statistic. The math underlying one such month is illustrated in FIG. 4, column 8.

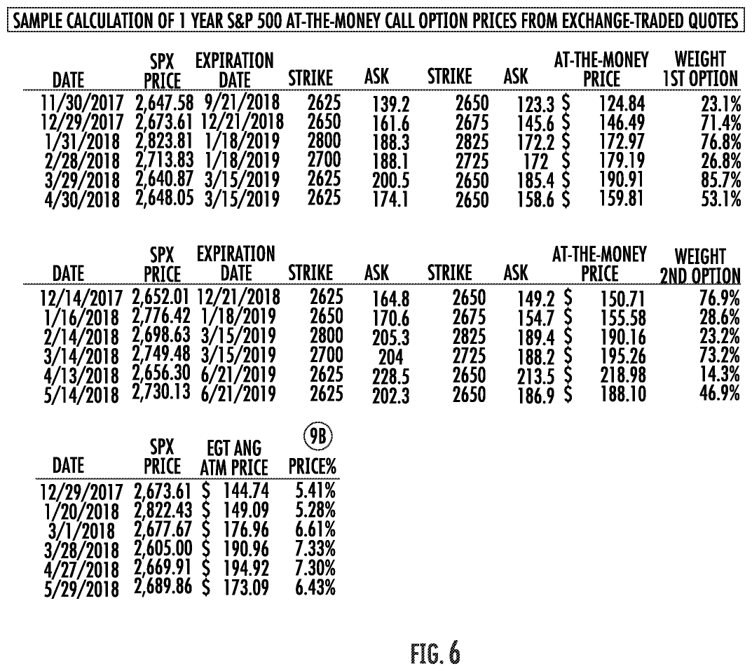

Step 9 in FIG. 2 also provides a more direct method of basing an indicator on option costs: calculate the market price of a standardized option. An example of a standardized option would be the price of a call option on the S&P 500 index with a strike price set at that day's current index value (e.g., “at the money”) for exactly 365 days to expiration. Column 9A on FIG. 3 shows the computed prices for this sample standardized call option for last trading of the prior month for the selected months in FIG. 3. To perform such method the computer would obtain quotes from a stock market exchange on SPX options expiring before and after the targeted maturity date, obtain quotes on strike prices above and below the targeted strike price to be able to interpolate for the standardized call option's market price. The combination of interpolations and calculations for the figures shown in column 9 on FIG. 3 are provided in FIG. 6 with the net result for each date shown in column 9B.

Once the system has determined the benchmark in step 2 and the indicator in step 5, it moves to the allocation decision to be determined in step 10. If the indicator from step 5 is less than or equal to the benchmark determined in step 2, the computer system executes the method by allocating the policy owner's segment funds to the traditional index-linked crediting strategy in step 11. If the indicator is more than the benchmark the policy owner's funds are allocated to the volatility-controlled index-linked crediting strategy in step 12. The funds remain in the determined index crediting strategy or strategies for the entire interest term. After the interest term, the segment (including any growth) may begin the process again or the funds in the segment may be reallocated to any other crediting strategy or benefits offered under the policy.

Steps 13 through 19 in FIG. 2 are provided for the sake of completeness regarding the overall process of managing caps and/or participation rates for policy owner's crediting strategies and the general correlation between market conditions that impact either the determination of the indicator or the benchmark and those same market conditions that impact the option budget and/or option costs.

Steps 13 through 19 in FIG. 2 illustrate that insurance companies manage the participation rates and caps for all available strategies within a product in accordance with that product's option budget. While the insurance company profitability is generally indifferent to the customer allocation, a method and process that can allocate the policy owner's funds optimally between traditional indexed and volatility-controlled indices would be valuable for the policy owner.

This process starts with step 13 to determine the product's option budget from the investment yields in step 14 and the product's pricing spread in step 15. The investment yield less the spread is the option budget (with adjustments for timing of option purchase).

Step 16 represents the process to determine the traditional indexed crediting strategy's cap and/or participation rate based on the option budget in step 13 and the current price of option costs in step 17. Note that the price of call options in step 17 is heavily influenced by the current market conditions regarding market volatility as illustrated in steps 6-9 in FIG. 2.

The method moves to step 19 where the insurance company sets the participation rate and/or cap for the volatility-controlled index crediting strategy based on the option budget from step 13 and the option costs for that strategy in item 20. Note that the option costs in step 20 are not influenced by the environment represented by steps 6-9; option costs for volatility-controlled indices are stable due to their dynamic algorithm that targets a constant level of volatility for the index.

It will be appreciated that each step of the present invention may be implemented with a computer or computer-based network as shown in FIG. 7. A computer represented by box 24 may be specifically programmed to carry out the steps described above and store information related thereto. For example, a computer may be used to store data related to the amount of funds in each segment, the beginning and ending dates of each segment, the value of the underlying indices needed to calculate the credited rates along with the caps, participation rates, and formulas needed to compute each segment's credited rate. Further, a computer may be used to assist with the calculations in steps 1 through 20 in FIG. 2, which result in many of the values set forth in the exemplary charts. . Thus, embodiments within the scope of the present invention include program products comprising computer-readable media for carrying or having computer executable instructions or data structures stored thereon.

Such computer-readable media can be any available media that can be accessed by a general purpose or special purpose computer. By way of example, such computer-readable media can comprise RAM, ROM, EPROM, EEPROM, CD-ROM or other optical storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general-purpose computer, special purpose computer, or special purpose processing device to perform a certain function or group of functions.

In addition to a system, the invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. In one embodiment, users such as insurance agents, policy owners, and beneficiaries may be able to access the network to provide and receive information about the individual policies or master product.

The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general-purpose computing device in the form of a conventional computer, including a processing unit, a system memory, and a system bus that couples various system components including the system memory to the processing unit. The system memory may include read only memory (ROM) and random-access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer -readable media provide nonvolatile storage of computer-executable instructions, data structures, program modules and other data for the computer.

Software and Web implementations of the present invention could be accomplished with standard programming techniques with rule-based logic and other logic to accomplish the various database searching steps, correlation steps, comparison steps and decision steps. It should also be noted that the words “component” or “module” as used herein is intended to encompass implementations using one or more lines of software code, and/or hardware implementations, and/or equipment for receiving manual inputs.

FIG. 7 illustrates the components of a general-purpose computing system connected to a general-purpose electronic network 21, such as a computer network. The computer network can be a virtual private network or a public network, such as the

Internet. As shown in FIG. 7, the computer system 22 includes a central processing unit (CPU) 24 connected to a system memory 26. The system memory 26 typically contains an operating system 25, a BIOS driver 28, and application programs 27. In addition, the computer system 22 contains input devices 29 such as a mouse or a is keyboard 33, and output devices such as a printer 32 and a display monitor 31, and a permanent data store, such as a database 34. The computer system generally includes a communications interface 30 to communicate to the electronic network 21. Other computer systems 23 and 23A also connect to the electronic network 21 which can be implemented as a Wide Area Network (WAN) or as an internetwork, such as the Internet. Data is stored either in many local repositories and synchronized with a central warehouse optimized for queries and for reporting. Data is also stored centrally in a dual use database. This system is one example of a system that could execute the method steps set forth above.

### Demonstrating the Invention and The Value to a Policy Owner

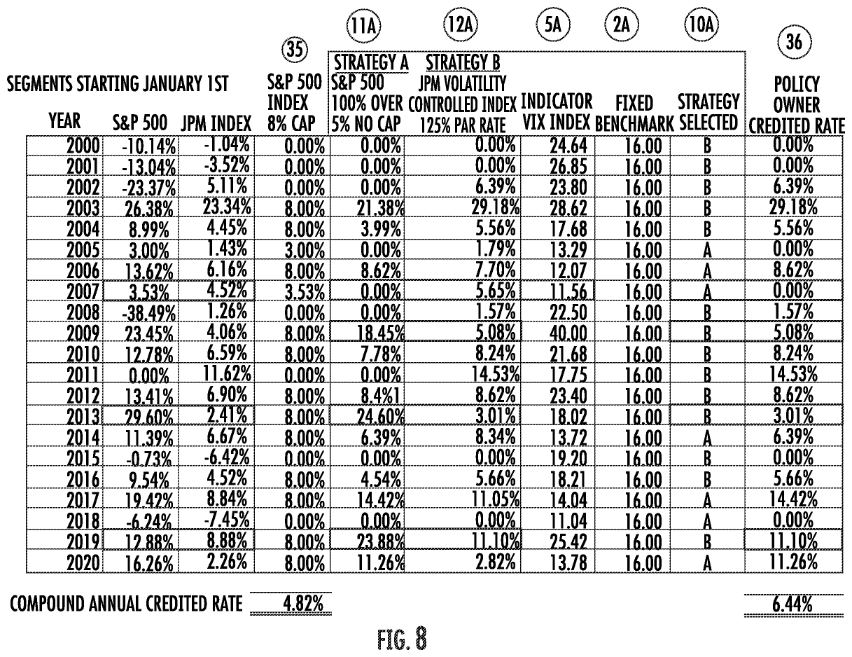

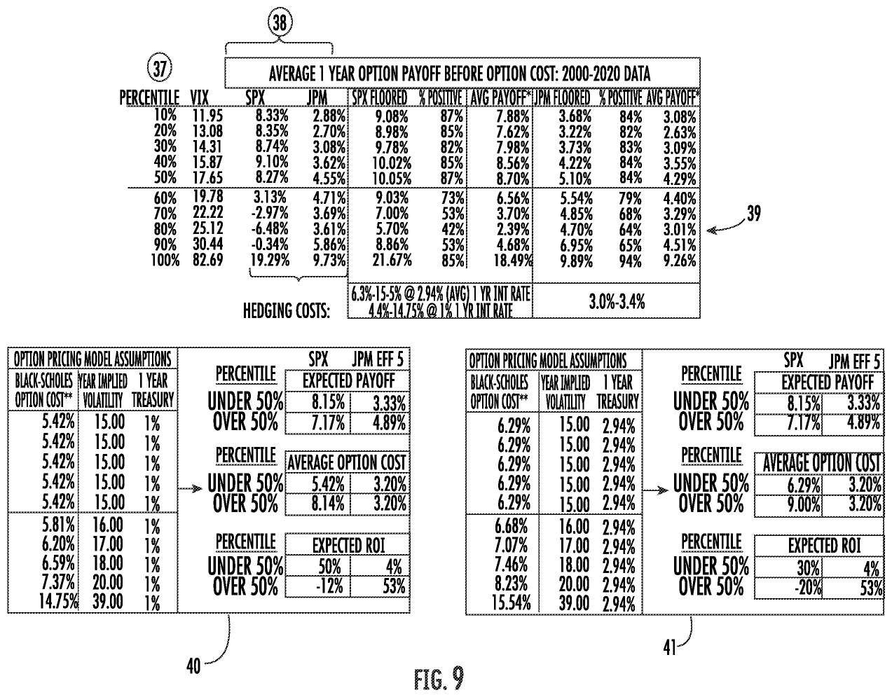

FIGS. 8 and 9 illustrate how the invention works for a sample case study and provides a sample quantification of the potential value to be created for policy owners using 21 years of historical data for one application of the method.

FIG. 8 shows 21 years of annual returns on the S&P 500 index (e.g., the traditional equity market index representing a constant, fixed exposure for the segment term) and a volatility-controlled index (the JP Morgan Efficiente 5 which is a diversified index managed by an algorithm that changes the allocation at the end of every month). A common index crediting strategy in the industry is the 1-year S&P 500 capped strategy: the policy owner receives 100% of the growth in the index over the 1-year term up to the cap. If the index growth is negative over the term, the credited rate is zero. This comparison assumes an 8% cap. Column 35 in FIG. 8 calculates that the compound annual credited rate for this traditional equity linked strategy to be 4.82% over the 21-year period with the annual segments starting the first day in January each year.

The method is demonstrated in FIG. 8 using a traditional equity-indexed crediting strategy that credits 100% of the S&P 500 growth over 5% each year. Instead of a capped strategy, Strategy A in column 11 credits none of the first 5% but 100% of all index growth over 5%. This is known as the “spread” method. Strategy B in column 12 is the volatility-controlled index crediting strategy. A fair comparison must start with the same option budget for Strategy A, B and the capped strategy being used for comparison. For this analysis it was determined that the average cost to hedge an 8% capped strategy on the S&P 500 index is comparable to a 5% threshold on the spread strategy (Strategy A) and a 125% participation rate on the volatility-controlled index (Strategy B), but only if the insurance company is purchasing options for Strategy A when the VIX® index (the indicator chosen from step 5 in FIG. 2 and shown in column 5A in FIG. 8) is under 16 (the benchmark chosen from step 2 in FIG. 2 and shown in column 2A in FIG. 8). When the VIX® index is over sixteen on the allocation date, the policy owner is allocated to the volatility-controlled index and the insurance company purchases options on that index.

In FIG. 8, calculated values for Strategy A (the traditional equity index-linked strategy) are shown in column 11A and calculated values for Strategy B (the volatility-controlled index) are shown in column 12A. the calculated indicator values are shown in column 5A and the calculated benchmark values are shown in column 2A. The strategy selected by the process of selecting where to allocate the policy owner funds (step 10 in FIG. 2) is illustrated in column 10A. The result of this allocation process is the policy owner credited rate in column 36. Of course, the method does not always predict the best investment strategy, as illustrated for years 2005, 2007, 2009, 2013, and 2019 wherein the opposite strategy would have resulted in higher gains. However, for this particular 21-year period the compound average credited rate of 6.44% exceeds the 4.82% earned with the traditional S&P 500 8% capped strategy.

A more robust analysis of the value of the invention's method is provided in FIG. 9. The study covered the period of 2000 through 2020 for an uncapped participation in the growth of the S&P 500 index vs. uncapped participation in the growth of the JP Morgan Efficiente 5. The JP Morgan index began operation in October 2010; data prior to that date was back-tested data using the developed algorithm. Notwithstanding the benefit of hindsight when the index was launched in 2010, the 2000-2010 time-period was useful data due to the extreme volatility experienced during 2000-2002 and 2008-2010.

The example illustrated in FIG. 9 uses the VIX® index to segment the data into ten equal segments of market volatility conditions for the start of each annual crediting segment (column 37). For purposes of context, the average annual return within each decile is shown for both the S&P 500 index and the JP Morgan Efficiente 5 index (item 38). This is shown only for context because the relevant data in a fixed indexed product application is the average gains when the respective index shows positive returns over the 12-month period vs. the cost of purchasing the option that mirrors the payoff of that call option. The relevant data to this analysis is the expected return as measured by the average gain, if positive, multiplied by the probability of a positive gain as shown in item 39.

The other half of the analysis compares the historical payoff of the options for each decile of volatility conditions to the expected option cost for that environment. As shown in items 13-20 in FIG. 2, the insurance company sets the policy owners cap or participation rate in the index growth based on the available option budget and the cost of the options. For the equity index options, many variables influence the market price of the call options but primarily market volatility, treasury rates and the dividend yield. The volatility-controlled index options for the JP Morgan index have generally been in the 3.0-3.4% range; for this analysis it is assumed the costs are 3.2%.

Assuming the insurance company consistently manages its caps and/or participation rates for all policy owner crediting strategy options, the value of the invention will manifest itself in the difference in the expected return on investment (“ROI”) for the call option. For example, if the company's option budget is 4% and the expected ROI on that option is 25% then the policy owner can expect to receive on average a 5% credited rate (4%×(1+25%)). The higher the option ROI, the better the performance for the policy owner.

The value of the invention's method to manage the allocation strategy for the policy owner will be validated by examining the expected ROI on the respective strategies in the different volatility environments. For illustrative purposes, FIG. 9 uses the VIX® index and groups the data evenly into the top and bottom 50th percentile of days. Examining the expected ROI for the two distinct index-linked crediting strategies for the two broad groupings of volatility environments will prove insightful to the value of the invention for policy owners.

Table 40 in FIG. 9 computes the expected ROI groups assuming SPX option costs are priced assuming a 1% 1-year Treasury. The price of the call options will generally increase as market volatility increases but 1-year options will be priced off expected market volatility over the following 12 months. Generally, it has been observed that these longer dated options show relatively stable option costs (holding all variables constant except the implied volatility used to calculate the cost of the option) when the 30-day VIX® index is below the median. Accordingly, this simple analysis assumes a 15% implied volatility to estimate the average cost of 1 year SPX options for all days the VIX® index is under the median (17.65); above the median VIX® index the cost of the 1-year options increase as the VIX® index increases.

Table 40 in FIG. 9 assumes SPX option costs are based on a 1% 1-year Treasury rate, 2% dividend yield, but vary the implied volatility as previously discussed. The analysis suggests the policy owner would expect an average credited rate of 50% more than the option budget when participating in the traditional equity linked strategy during low market volatility conditions and 53% more than the option budget when participating in the volatility-controlled index linked strategy during high volatility conditions (as determined in FIG. 9 by the VIX® index being above 17.65 at the start of each annual segment).

The performance of these two groups was substantially better than the alternative choices: 4% more than the option budget if they chose the volatility-controlled index strategy when the VIX® index was less than 17.65 (e.g., low volatility conditions as defined by this combination of indicator and benchmark) and a credited rate 12% less than the option budget if they chose the traditional equity-linked strategy when entering during high volatility market conditions.

Table 41 in FIG. 9 shows a sensitivity test of the conclusion by assuming the S&P 500 option cost pricing assumed an average 2.94% 1-year Treasury rate. As shown in table 41, the conclusion is the same as that reached in table 40: the policy owner is better off being directed to the traditional equity index-linked strategy when market volatility is low and the volatility-controlled index strategy when market volatility is high. The only difference in table 41 vs. item 40 is that the traditional equity index-linked strategy has a lower performance since the option costs are higher (which would be reflected with a lower participation rate).

Insurance companies selling fixed indexed life and annuity products have been dealing with a perfect storm of falling investment yields and rising market volatility/option costs. In response to these challenges, companies are increasingly promoting volatility-controlled indices inside the products along with the traditional equity indexed crediting strategies. Embodiments of the present invention use a predefined rule based on an indicator and a benchmark to determine the allocation into one or more indexes (one of which is a volatility-controlled index) for each interest term. This invention is timely to help policy owners navigate their strategy allocation choices and help insurance companies better manage the volatility of the hedging costs backing these products.

The foregoing description of preferred embodiments of the invention has been presented for purposes of illustration and description. It is not intended to be exhaustive or to limit the invention to the precise form disclosed, and modifications and variations are possible in light of the above teaching or may be acquired from practice of the invention. The embodiments were chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is as follows:

1. A computer-implemented method for processing data related to a fixed indexed financial product issued by a provider to an owner, wherein the fixed indexed financial product has a segment that is at least a portion of an account value, said method comprising:
determining an indicator;
determining a benchmark;
comparing the indicator to the benchmark;
allocating the segment to a traditional index linked crediting strategy if the indicator is less than the benchmark;
allocating the segment to a volatility-controlled index linked crediting strategy if the indicator is more than the benchmark; and
storing data related to the fixed indexed financial product in a data storage device wherein said data includes information about the indicator, the benchmark, the term, and the segment.

2. The method of claim 1 wherein the fixed indexed financial product is a life insurance product.

3. The method of claim 1 wherein the fixed indexed financial product is an annuity product.

4. The method of claim 1 wherein the benchmark is determined based on treasury rates.

5. The method of claim 1 wherein the fixed indexed financial product has a duration and the benchmark is fixed for the duration of the financial product.

6. The method of claim 1 wherein the fixed indexed financial product has a duration and the benchmark is variable over the duration of the policy.

7. The method of claim 1 wherein the indicator is an external indicator.

8. The method of claim 1 wherein the indicator is one of the VIX® index and the market price for VIX® futures contracts.

9. The method of claim 1 wherein the indicator is determined using a calculation of realized volatility of an underlying index over a pre-determined time-period.

10. The method of claim 1 wherein the indicator is determined using market quotes for call options based on an underlying index for a pre-determined interest term and standardized set of option parameters.

11. The method of claim 1 wherein the segment includes the entire account value.

12. The method of claim 1 wherein a special purpose computer is used to perform the comparing and allocating steps.

13. The method of claim 1 further comprising crediting growth accumulated during an interest term to the account value.

14. The method of claim 1 further comprising the step of entering the data associated with the fixed indexed financial product into the data storage device using an input device.

15. A computer system for processing data related to a fixed indexed financial product issued by a provider to an owner, wherein the fixed indexed financial product has a segment that is at least a portion of an account value, said system comprising:
an input device that receives data about the fixed indexed product;
a data storage device used to receive and store data related to a segment, a benchmark, and an indicator;
a processor programmed with executable code that when executed causes the processor to:
determine an indicator;
determine a benchmark;
compare the indicator to the benchmark;
allocate the segment to a traditional index linked crediting strategy if the indicator is less than the benchmark; and
allocate the segment to a volatility-controlled index linked crediting strategy if the indicator is more than the benchmark.

16. The method of claim 15 wherein the fixed indexed financial product is a life insurance product.

17. The method of claim 15 wherein the fixed indexed financial product is an annuity product.

18. The method of claim 15 wherein the benchmark is determined based on treasury rates.

19. The method of claim 15 wherein the fixed indexed financial product has a duration and the benchmark is variable over the duration of the financial product.

20. The method of claim 15 wherein the indicator is an external indicator.

21. The method of claim 15 wherein the indicator is one of the VIX® index and the market price for VIX® futures contracts.

22. The method of claim 15 wherein the segment includes the entire account value.

23. A computer program product for processing data related to a fixed indexed financial product issued by a provider to an owner, wherein the fixed indexed financial product has a segment that is at least a portion of an account value, the computer program product comprising at least one non-transitory computer-readable storage medium having computer-executable program code instructions stored therein, the computer-executable program code instructions comprising program code instructions to:
determine an indicator;
determine a benchmark;
compare the indicator to the benchmark;
allocate the segment to a traditional index linked crediting strategy if the indicator is less than the benchmark;
allocate the segment to a volatility-controlled index linked crediting strategy if the indicator is more than the benchmark; and
store data related to the fixed indexed financial product in a data storage device wherein said data includes information about the indicator, the benchmark, the interest term, and the segment.

24. The method of claim 23 wherein the fixed indexed financial product is a life insurance product.

25. The method of claim 23 wherein the fixed indexed financial product is an annuity product.

26. The method of claim 23 wherein the benchmark is determined based on treasury rates.

27. The method of claim 23 wherein the fixed indexed financial product has a duration and the benchmark is variable over the duration of the financial product.

28. The method of claim 23 wherein the indicator is an external indicator.

29. The method of claim 23 wherein the indicator is one of the VIX® index and the market price for VIX® futures contracts.

30. The method of claim 23 wherein the segment includes the entire account value or a partial amount of the account value.
